(19) United States
(12) Patent Application Publication
(10) Pub. No.: US 2009/0236811 A1
(43) Pub. Date: Sep. 24, 2009

(54) Skateboard Riser with Integrated LED Light

(76) Inventor: Jon Scott Lewis, San Diego, CA (US)

Correspondence Address: ERIC HANSCOM, 7395 PORTAGE WAY, CARLSBAD, CA, 92011, US

(21) Appl. No.: 12/406,864

(22) Filed: Mar. 18, 2009

Related U.S. Application Data
(60) Provisional application No. 61/037,778, filed on Mar. 19, 2008.

(51) Int. Cl. A63C 17/01; B60Q 1/02

(52) U.S. Cl. 280/87.042; 362/459

(57) ABSTRACT

A riser for a skateboard with an integrated LED light is disclosed. The riser is made of clear acrylic and attaches between the deck and the truck of the skateboard. The riser is battery powered and rechargeable. The LED emits light that travels through the riser and exits in almost all directions, thereby illuminating the space directly in front of and around the skateboard.

### CROSS REFERENCE TO RELATED APPLICATIONS

This application is a non-provisional application of U.S. Provisional Patent Application No. 61/037,778 filed on Mar. 19, 2008, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of skateboards, and more specifically toward a riser for a skateboard with an integrated LED light. The riser is made of clear acrylic and attaches between the deck and the truck of the skateboard. The riser is battery powered and rechargeable. The LED emits light that travels through the riser and exits in almost all directions, thereby illuminating the space directly in front of and around the skateboard.

Lights, especially flashing lights, can create a unique visual appearance. The skateboarding industry strives to create new ways for skateboarders to differentiate themselves from other riders. As of yet, there are no systems or devices for emitting light from skateboards that can integrate fully into the skateboard and do not affect the skateboarder's ability to use the skateboard.

Skateboarding is also a fun and exciting sport that is usually enjoyed during the day. It can be more dangerous at night, however, since it is difficult for others to see the skateboarder. Street lighting is often inadequate or inconsistent. Bicyclists have overcome this issue by attaching lights to the handlebars or rear reflectors of their bicycles. Skateboarders do not have such a convenient place to attach a light that is capable of warning others of the skateboarder's presence.

Thus there has existed a long-felt need for source of light that skateboarders may attach to their skateboards to emit light and illuminate the area immediately around their skateboard. It should be visible to others in relative close proximity to the skateboarder not only for the novelty of lights on skateboard, but also to alert others of the presence of a skateboarder for safety reasons. Additionally, the light-emitting device should not affect the skateboarder's ability to ride and use all the available features of the skateboard. The device should be easy to mount and the batteries used to power the skateboard should be rechargeable or easily replaced.

The current invention provides just such a solution by having a riser for a skateboard with an integrated LED light. The riser is made of clear acrylic and attaches between the deck and the truck of the skateboard. The riser is battery powered and rechargeable. The LED emits light that travels through the riser and exits in almost all directions, thereby illuminating the space directly in front of and around the skateboard.

### SUMMARY OF THE INVENTION

The current invention provides a skateboard with a riser that illuminates areas around the skateboard. It includes a battery, an LED, a switch, and a means for charging the battery. It is installed between the deck and one of the trucks of the skateboard. It may be necessary to install an additional riser on the opposing truck to maintain a level height of the deck of the skateboard. The light produced by the current invention can be used for safety and for fun. Other individuals, such as a driver of a car, will be more likely to avoid the skateboarder because of the visual notification of his or her presence. Also, the lights create a new and novel affect that has never before been seen. Maneuvers performed on a skateboard can be accentuated by lights, especially flashing lights. For example, the light emitted from the current invention can create a glow around the bottom of the board while traveling along the ground, but can also create eye-catching effects when flips are performed.

It is a principal object of the invention to provide a riser for a skateboard that emits light in substantially all directions around the skateboard.

It is another object of the invention to provide a rechargeable, battery-powered riser for a skateboard that produces light.

It is a final object of this invention to provide a light emitting riser that can easily be installed on a skateboard.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

FIG. 1 is a bottom view of the light-emitting riser.

FIG. 2 is a side view of the light-emitting riser.

FIG. 3 is a front view of a skateboard with the light-emitting riser.

FIG. 4 is a side view of a skateboard with the light-emitting riser.

FIG. 5 is a lower perspective view of a skateboard with the light-emitting riser.

FIG. 6 is a view of a skateboarder riding a skateboard with an integrated light-emitting riser.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings.

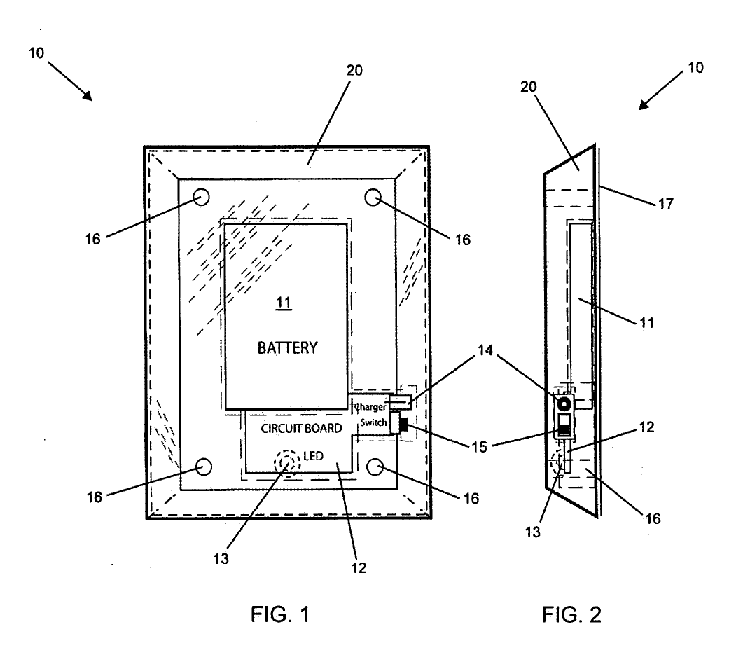

FIG. 1 is a bottom view of the light-emitting riser. The light-emitting riser 10 includes a clear case 20 that is molded from a clear acrylic block. Other materials may be used to create the clear case 20, but must be able to withstand the rigors of being a skateboard riser. The clear case is preferably created from a material that is transparent, but the material may also be translucent. Inside of the clear case 20 are a battery 11, circuit board 12, and a means for emitting light, such as a light emitting diode, or LED 13. The battery 11 powers the circuit board 12, which in turn powers the LED 13. Also connected to the circuit board 12 are a charging port 14 and a switch 15. The switch 15 is used to turn the device on and off, or more specifically, to turn the LED 13 on and off. The charging port 14 is used to charge the battery 11 such that the same battery 11 may be used repeatedly. Attachment holes 16 are used to connect the light-emitting riser 10 to the deck of a skateboard. A simpler version of the above light-emitting riser could include a clear case, battery, LED, and switch, whereby the battery is connected to the LED via the switch, and the switch turns the LED on and off.

Various different types of batteries can be used to power the device. Preferably, the battery is rechargeable such that it need not be replaced every time the battery is drained. The battery must be able to fit into a relatively small space yet be able to power an LED light for an extended period of time. It must meet the voltage requirements of the circuit board used to power the LED, if applicable. A slim battery that can produce approximately 4.5 volts has been found to meet these requirements.

While a single LED has been described, it is nonetheless possible, and even preferable, to use multiple LEDs. The LEDs can all be of the same color to create a more intense light, or can be of different colors. It is intended that the main purposes of the LEDs is to produce sufficient lighting to make objects proximate to the skateboard visible, but it may also be beneficial to use the lights as accent lighting, even during the day. The LEDs may be clustered together inside of the clear case, or may be evenly or randomly distributed throughout. Further, different sources of light other than LEDs are possible without departing from the scope of the current invention. There are many different types of small light bulbs that can be used in the current invention, so long as they are small enough to fit inside of the clear case and can produce a sufficient amount of light.

A charging port is used to connect a power source to the device to recharge the battery. Various different types of ports are possible, and may depend on the battery and voltage requirements of the circuit. The charging port can include a proprietary configuration, or can use a standard plug size or even a USB power connector. Additionally, the charging port can be connected to another battery that recharges the battery inside of the clear case, powers the circuit board and therefore the LED, or both. A solar cell may also be used to power the circuit board, recharge the battery, or both. It can be connected directly to the circuit or connected to the charging port. The solar cell that collects light and transforms it into an electrical current can be located externally from the skateboard, or integrated into the deck of the board.

In its simplest form, the switch is an on-off switch that is used to turn the LED light on and off. A light sensitive switch can also be used, such that the LED light is automatically turned on when the level of ambient light falls below a specified level. The switch can also be a multi-way switch that causes the circuit board to perform different functions depending upon the position of the switch. For example, the switch can be a three-way switch that turns the LED light on, off, or cause it to flash. If there are multiple LEDs, the circuit board can cause them all to flash together, in sequence, or to have the individual LEDs flash randomly. Other patterns and lighting options are possible without departing from the scope of the current invention.

As described above, the circuit board can be used to direct the flow of energy from the battery to the LEDs depending on the position of the switch. Various different circuit boards are available and well known in the art that can create a plethora of lighting effects. While a circuit board has been shown throughout the figures, it is nonetheless possible that the current invention could operate without a circuit board. The components of the circuit could be built directly into the clear case. Alternatively, the circuit could be placed entirely within the one or more LEDs. Further, multiple circuits and/or circuit boards could be used with the current invention.

FIG. 2 is a side view of the light-emitting riser. The light-emitting riser 10 includes a clear case 20. Inside of the clear case 20 are a battery 11, circuit board 12, and a light emitting diode, or LED 13. The battery 11 powers the circuit board 12, which in turn powers the LED 13. Also connected to the circuit board 12 are a charging port 14 and a switch 15. Attachment holes 16 are used to connect the light-emitting riser 10 to the deck of a skateboard. On the top of the light-emitting riser 10 is a layer of reflective foil 17. The layer of reflective foil 17 reflects light that would normally be incident upon the lower side of the deck. Other reflective materials may be used to achieve this goal of reflecting the light away from the deck of the skateboard and towards the ground below, thereby increasing the effective brightness of the light-emitting riser 10.

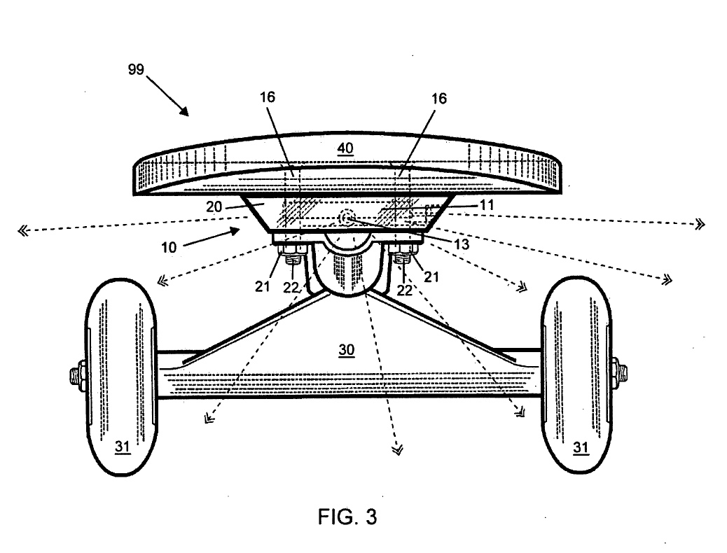

FIG. 3 is a front view of a skateboard with the light-emitting riser. The light-emitting riser 10 is attached to the deck 40 of the skateboard 99. Bolts 22 travel through the deck 40 of the skateboard 99, the clear case 20 of the light-emitting riser 10, and a truck 30 to secure the truck 30, lighting-emitting riser 10, and the deck 40 together. Other means of attachment are possible, including adhesives, magnets, and molding the clear case 20 and the deck 40 together. Nuts 21 secure the bolts 22. Wheels 31 attach to the truck 30. A battery 11 is located inside of the clear case 20 and powers the LED 13. Dashed lines with arrows on the end represent paths of light emitted from the light-emitting riser 10.

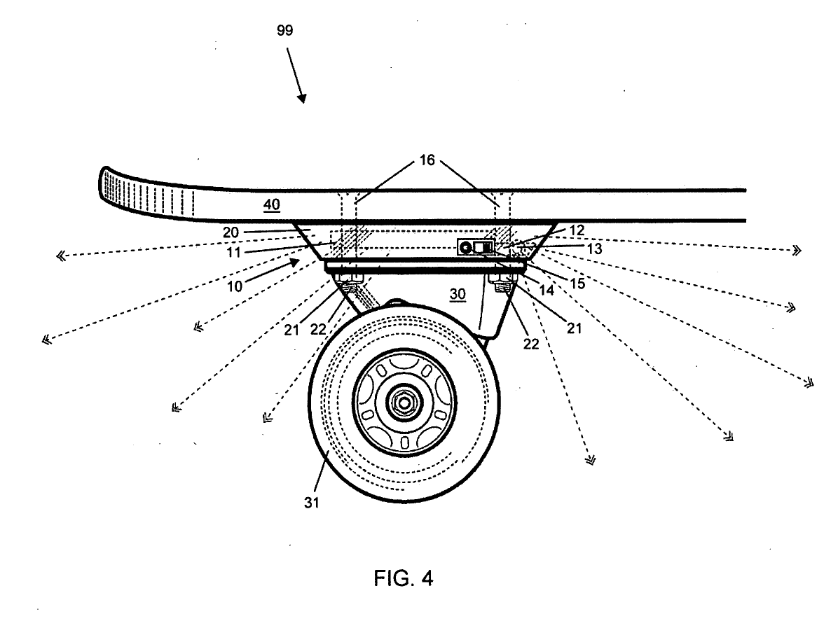

FIG. 4 is a side view of a skateboard with the light-emitting riser. The light-emitting riser 10 is attached to the deck 40 of the skateboard 99. Bolts 22 travel through the deck 40 of the skateboard 99, the clear case 20 of the light-emitting riser 10, and a truck 30 to secure the truck 30, lighting-emitting riser 10, and the deck 40 together. Nuts 21 secure the bolts 22. Wheels 31 attach to the truck 30. A battery 11 is located inside of the clear case 20 and powers the circuit board 12 and LED 13. A switch 15 is used to turn the LED 13 on and off and a recharging port 14 is used to recharge the battery 11. Dashed lines with arrows on the end represent paths of light emitted from the light-emitting riser 10.

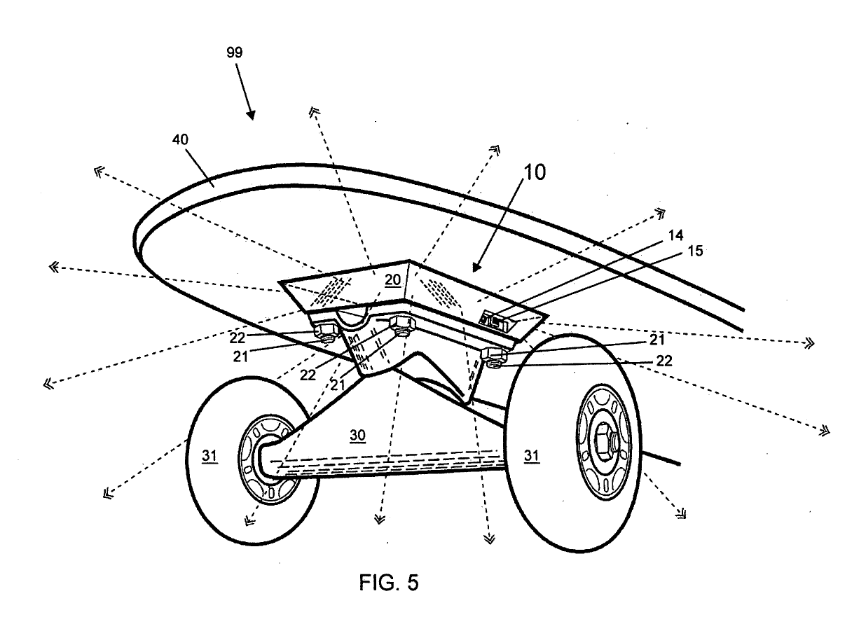

FIG. 5 is a lower perspective view of a skateboard with the light-emitting riser. The light-emitting riser 10 is attached to the deck 40 of the skateboard 99. Bolts 22 travel through the deck 40 of the skateboard 99, the clear case 20 of the light-emitting riser 10, and a truck 30 to secure the truck 30, lighting-emitting riser 10, and the deck 40 together. Nuts 21 secure the bolts 22. Wheels 31 attach to the truck 30. A switch 15 is used to turn the light-emitting riser 10 on and off and a recharging port 14 is used to recharge the battery. Dashed lines with arrows on the end represent paths of light emitted from the light-emitting riser 10.

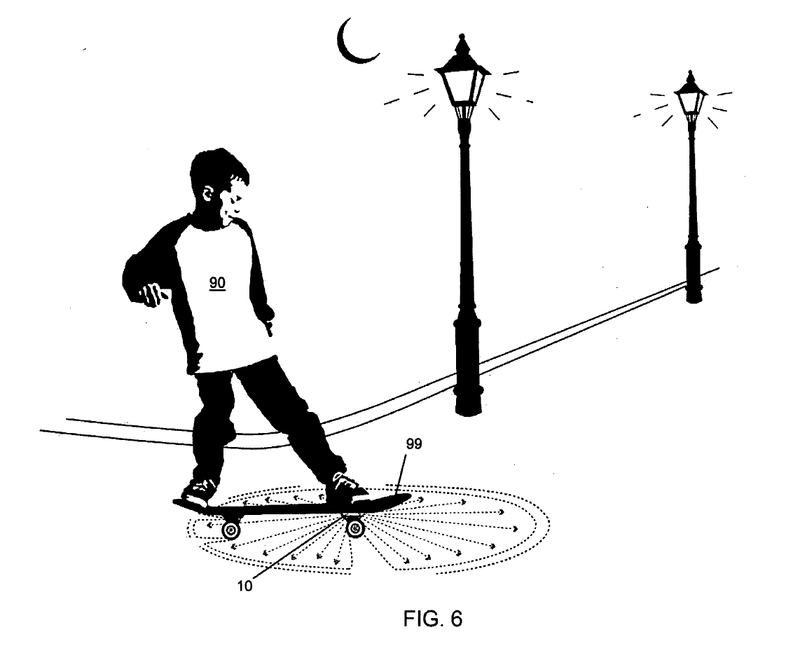

FIG. 6 is a view of a skateboarder riding a skateboard with an integrated light-emitting riser. The skateboarder 90 is riding a skateboard 99 equipped with a light-emitting riser 10. Dashed lines with arrows on the end represent paths of light emitted from the light-emitting riser 10. Different intensities of light are possible by changing the number or type of LEDs or different sources of light, thereby increasing or decreasing the effective distance the light-emitting riser 10 can illuminate.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A skateboard riser comprising
a clear case, a battery, a means for emitting light, and a switch,
where the battery and means for emitting light are contained within the clear case, where the clear case can be secured between the deck of a skateboard and the truck of a skateboard.

2. The skateboard riser of claim 1, where the clear case is transparent.

3. The skateboard riser of claim 1, where the battery is rechargeable.

4. The skateboard riser of claim 3, further comprising a recharging port.

5. The skateboard riser of claim 3, further comprising a solar cell.

6. The skateboard riser of claim 1, where the means for emitting light is a light emitting diode.

7. The skateboard riser of claim 1, where the means for emitting light is a plurality of light emitting diodes.

8. The skateboard riser of claim 7, where all of the plurality of light emitting diodes emit the same color of light.

9. The skateboard riser of claim 1, where the switch is a two-way switch.

10. The skateboard riser of claim 1, where the switch is a three-way switch.

11. The skateboard riser of claim 1, where the clear case comprises a layer of reflective foil.

12. The skateboard riser of claim 1, further comprising a circuit board, where the circuit board is contained within the clear case.

13. A skateboard riser comprising
a clear case, a battery, a light emitting diode, and a switch,
where the battery and light emitting diode are contained within the clear case,
where the clear case can be secured between the deck of a skateboard and the truck of a skateboard, and where the battery is rechargeable.

14. The skateboard riser of claim 13, further comprising a recharging port.

15. The skateboard riser of claim 13, further comprising a solar cell.

16. The skateboard riser of claim 13, further comprising an additional light emitting diode, where the additional light emitting diode is contained within the clear case.

17. The skateboard riser of claim 13, further comprising a circuit board.

18. A method of skateboarding comprising the steps of
obtaining a skateboard, where the skateboard comprises a deck, truck, and riser, where the riser comprises a clear case, a battery, a light emitting diode, a circuit board, a recharging port, and a switch, where the battery, light emitting diode, circuit board, and the switch are contained within the clear case, where the clear case can be secured between the deck of the skateboard and the truck of the skateboard, where the battery is rechargeable, where the recharging port accepts an electrical connection that recharges the battery, and where the battery provides power to the circuit board, where the circuit board powers the light emitting diode, where the switch can turn the light emitting diode on or off;
turning the switch to the on position such that the light emitting diode emits light; and
performing a maneuver on the skateboard.

19. The method of claim 18, where the switch is a three-way switch, where the switch can be in a first, second, or third position, where the light emitting diode does not emit light when the switch is in the first position, where the light emitting diode emits light when the switch is in the second position, and where the light emitting diode flashes light when the switch is in the third position.

20. The skateboard riser of claim 18, where the clear case comprises attachment holes and a layer of reflective foil, where the attachment holes are used to secure the truck of the skateboard, the skateboard riser, and the deck of the skateboard together.
